(19) United States
(12) Patent Application Publication
(10) Pub. No.: US 2013/0237357 A1
(43) Pub. Date: Sep. 12, 2013

(54) DUPLEX TOOTHED CHAIN AND ARRANGEMENT COMPRISING SUCH A TOOTHED CHAIN AND AN EXTERNAL TOOTHING OF A TOOTHED CHAIN ENGAGEMENT DEVICE

(71) Applicants: Thorsten Meyer, Laatzen (DE); Rainer Albes, Hildesheim (DE)

(72) Inventors: Thorsten Meyer, Laatzen (DE); Rainer Albes, Hildesheim (DE)

(73) Assignee: Robert Bosch GmbH, Stuttgart (DE)

(21) Appl. No.: 13/606,086

(22) Filed: Sep. 7, 2012

(30) Foreign Application Priority Data
Sep. 8, 2011 (DE) 10 2011 113 935.8

(51) Int. Cl. F16G 13/04

(52) U.S. Cl. CPC F16G 13/04
USPC 474/212

(57) ABSTRACT

A duplex toothed chain includes a drive toothing that defines a drive toothing pitch circle, a driven toothing that defines a driven toothing pitch circle, toothed links, and joint links. The toothed links define joint apertures that are spaced at intervals from one another in a longitudinal direction and that are configured to receive the joint links. The joint apertures define a joint aperture pitch circle extending in the longitudinal extent of the duplex toothed chain. The driven toothing pitch circle is different from the joint aperture pitch circle and is arranged radially further distant from the joint aperture pitch circle than the drive toothing pitch circle is arranged radially distant from the joint aperture pitch circle. The differences in the toothing pitch circles increase the engagement efficiency.

This application claims priority under 35 U.S.C. §119 to patent application no. DE 10 2011 113 935.8, filed on Sep. 8, 2011 in Germany, the disclosure of which is incorporated herein by reference in its entirety.

### BACKGROUND

The disclosure relates to a duplex toothed chain having a drive toothing, a driven toothing, toothed links and joint links, in which the toothed links comprise joint apertures spaced at intervals from another in a longitudinal direction for receiving the joint links, the joint apertures formulating a joint aperture pitch circle extending in the longitudinal extent of the duplex toothed chain.

The disclosure also relates to an arrangement comprising at least one duplex toothed chain having a drive toothing and a driven toothing, and comprising at least one external toothing of a toothed chain engagement device, in which the driven toothing and the external toothing intermesh in a meshing area, and in which the driven toothing formulates a driven toothing pitch circle.

Toothed chains of the generic type are well known in the prior art in the context of tangential drives. Frequently, one of the distinctive features of these known duplex toothed chains is the presence of symmetrical links or alternately laid single-toothed links, which serve to provide a drive toothing on the one hand and a driven toothing on the other. Here the link contour of the toothed links used is substantially designed for the optimum possible wrap contact engagement with a sprocket, which serves to return and/or drive a duplex toothed chain. Doing this, however, often reduces the engagement efficiency of a toothed chain engagement device, such as a sprocket or a rack, in engagement with the driven toothing of the duplex toothed chain.

The object of the disclosure is to further develop toothed chains of the generic type, in such a way as to avoid at least the aforementioned disadvantage.

### SUMMARY

The object of the disclosure is achieved by a duplex toothed chain having a drive toothing, a driven toothing, toothed links and joint links, in which the toothed links comprise joint apertures spaced at intervals from one another in a longitudinal direction for receiving the joint links, the joint apertures formulating a joint aperture pitch circle extending in the longitudinal extent of the duplex toothed chain, and the duplex toothed chain having a driven toothing pitch circle of the driven toothing, which is different from the joint aperture pitch circle and which is arranged radially further distant from the joint aperture pitch circle than a drive toothing pitch circle of the drive toothing is arranged radially distant from the joint aperture pitch circle.

It will be obvious that the chain here under consideration always relates to a duplex toothed chain in a set state, in which the duplex toothed chain is bent in the direction of its drive toothing, thereby allowing it to be wrapped, at least partially, around a corresponding drive sprocket.

The fact that the driven toothing pitch circle is different from the joint aperture pitch circle, in such a way that it is arranged radially further distant from the joint aperture pitch circle than a drive toothing pitch circle of the drive toothing is arranged radially distant from the joint aperture pitch circle, means that the engagement ratios between a driven toothing side toothed chain engagement device, such as sprockets or other toothed components engaging externally in the driven toothing, and the present toothed chain are improved to an exceptional degree. This applies both to an engagement on the driven toothing at a wrap contact area, on which the duplex toothed chain wraps at least partially around a sprocket on the drive toothing side, and to a tangential engagement.

According to the prior art, with regard to their drive toothing and driven toothing, duplex toothed chains have a drive toothing pitch circle and a driven toothing pitch circle that are equidistant from the joint aperture pitch circle.

With regards to their geometry, pitch circles in toothed chains, as also the present joint aperture pitch circle and the present drive and driven toothing pitch circles, are also calculated by d=m·z=(p/p)·z, where d=pitch diameter; m=module; z=number of teeth and p=circular pitch. The pitch circle varies directly according to the pitch. In the extended state of the duplex toothed chain, without any setting angle of the toothed links, the joint aperture pitch circle lies on the joint centre-point line. Depending on the bending of the duplex toothed chain, however, a slight shift still occurs owing to a displacement of the points of contact between the joint links and the toothed links, but for the chain under consideration here this is negligible.

For the purposes of the disclosure the driven toothing pitch circle and the drive toothing pitch circle are each defined by a central area running transversely to a rolling length, around which area teeth engaging radially in the duplex toothed chain are able to roll on the teeth of the toothed links. The distance from the respective central area here gives the diametral dimension for the driven toothing pitch circle and for the drive toothing pitch circle. Here it may be, for example, that between two teeth of the driven toothing and a corresponding driven sprocket rolling upon one another, only a fixed line of contact ensues, which does not migrate along the rolling length and which would then clearly define the position of the driven toothing pitch circle.

In an exceptionally advantageous design variant the driven toothing has a driven toothing pitch and the drive toothing has a drive toothing pitch, the driven toothing pitch being greater than the drive toothing pitch.

It is especially advantageous in this context if the driven toothing has a driven toothing module and the drive toothing has a drive toothing module, the driven toothing module being greater than the drive toothing module.

This affords a particularly simple design approach to obtaining a substantially improved engagement geometry of the driven toothing with a driven sprocket, particularly with regard to a long engagement length or a high contact ratio, regardless of an engagement geometry of the drive toothing of the duplex toothed chain.

For the same number of teeth of the set duplex toothed chain, this results in a further pitch circle, which is important only for the engagement ratios between the driven toothing and the driven sprocket meshing herewith.

To this extent distinctive features of the duplex toothed chain are a driven toothing pitch circle and a drive toothing pitch circle, which are arranged at different radial distances from the joint aperture pitch circle.

The present driven toothing pitch circle can be seen particularly clearly from the duplex toothed chain in a wrap contact area, in which the toothed chain on the drive toothing side meshes with an inner sprocket and in so doing wraps at least partially around this.

Accordingly, it is a design advantage if the toothed links are arranged asymmetrically with regard to the drive toothing and the driven toothing.

For the purposes of the disclosure sprockets and/or racks are primarily defined as toothed chain engagement device.

In a further exceptionally advantageous design variant the duplex toothed chain, at least on the driven toothing side, has a driven toothing tooth contour with a variable generating curve from at least two individual teeth, arranged so that they are rotationally moveable in relation to one another. This allows the engagement geometry on the part of the toothed chain to be adjusted particularly well to a corresponding driven sprocket.

According to a further aspect of the disclosure, the present object is also achieved by an arrangement comprising at least one duplex toothed chain having a drive toothing and a driven toothing, and comprising at least one external toothing of a toothed chain engagement device, in which the driven toothing and the external toothing intermesh in a meshing area, and in which the driven toothing formulates a driven toothing pitch circle, the driven toothing pitch circle being arranged inside the external toothing of the toothed chain engagement device.

Shifting the chain-side pitch circle, in particular, makes for a design allowing individual wrap-around drives to be coupled together more easily for transmitting power. In the case of tangential drives, an improved overlap contact of the geometries, in particular, affords uniform movements and speeds. External components are to this extent capable of more efficient tangential engagement in the duplex toothed chain and can therefore be entrained more reliably by the present toothed chain.

In a preferred design variant the driven toothing pitch circle is arranged radially closer to the joint aperture pitch circle than is the drive toothing pitch circle, thereby affording, in particular, an especially efficient engagement of an outer sprocket in the external contour of the present toothed chain in the wrap contact area of an inner sprocket.

It is furthermore advantageous if the driven toothing pitch circle in the meshing area at least partially coincides with an external toothing pitch circle of the external toothing, or touches the external toothing pitch circle. An especially long contact with little abrasion can thereby be achieved between the duplex toothed chain and the teeth of a sprocket.

An especially close engagement on the driven toothing can be obtained if the driven toothing pitch circle, with regard to a toothed chain bent in the direction of the drive toothing, has a larger pitch than the pitch of the joint aperture pitch circle, as has already been mentioned above.

It is also exceptionally advantageous if the driven toothing has a module toothing having a pressure angle of between 15° and 30°, preferably between 19° and 25°.

A pressure angle of 20° is preferably provided, since this affords an especially long engagement length on the driven toothing with regard to the driven sprocket.

To this extent an inner side and an outer side of the duplex toothed chain may differ considerably in their respective design shape, yet further geometries and angles also being possible, however, depending on the particular application.

The inner side here relates to the drive toothing, which wraps at least partially around a drive sprocket. Accordingly, the outer side relates to the driven toothing, which meshes with a driven sprocket.

The teeth arranged on the driven toothing side are advantageously of a higher design than the teeth arranged on the drive toothing side. In addition the teeth of the driven toothing are ideally distinguished by cropped tooth ends, whereas tooth ends of the teeth of the drive toothing advantageously taper more sharply to a point. To this extent the teeth of the drive toothing and the teeth of the driven toothing each have different half-width values, due to their different design shape. Particularly when taken cumulatively, an improved engagement behavior can thereby be obtained both on the drive toothing and on the driven toothing. The half-width values of the driven toothing are preferably greater than those of the drive toothing.

The tooth geometry of the driven sprocket and of the driven toothing of the present duplex toothed chain may advantageously be selected independently of the arrangements for the drive toothing. The tooth geometry preferably differs in that the driven teeth are larger than the drive teeth.

The generating curve around correspondingly external set toothed link teeth may ideally correspond virtually to a normal module-toothed spur gear having a 20° pressure angle, the driven toothing pitch circle of the duplex toothed chain and the driven sprocket pitch circle of the externally engaging driven sprocket both being situated inside the external toothing of the driven sprocket and being able to roll upon one another, as is the case in a pair of mating spur gears.

In a symmetrically arranged toothed link having the same tooth shape on both sides, a generating curve around the successive set toothed links results in different tooth shapes on the inwardly bent side—drive toothing—and on the outwardly bent side—driven toothing. Since a duplex toothed chain of this type is substantially a wrap-around drive and this toothed chain generally comprises a drive sprocket having a plurality of teeth, the toothed link arranged symmetrically with regard to this is optimized for this inner or drive-side engagement, that is to say both on the drive toothing side and on the driven toothing side, because of the symmetrical design. To this extent the tooth shapes of the external toothing of the driven sprocket, must be corrected, particularly with regard to a profile shift and/or an undercut. Owing to an inverse set on the outside of the toothed chain, a sprocket engaging herein has a very unfavorable tooth shape, in which any satisfactory engagement is virtually no longer possible. This detrimental situation is advantageously absent here.

It is advantageous overall if the duplex toothed chain comprises guide links, which are designed to exert a guiding action on one side only, preferably on the drive toothing. This serves to ensure that the toothed chain runs especially quietly and with little abrasion, since it is radially guided substantially just on the inner sprockets. Moreover, on the driven toothing side, the toothed chain must impose virtually no restrictions with regard to the width of a toothed chain engagement device meshing with the toothed chain. Furthermore, a transmission accuracy with regard to tangential drives can advantageously be increased.

A further improvement of the running characteristics of the duplex toothed chain can be obtained if the joint links each comprise a rocker link. It should be mentioned at this point, however, that the joint links can also only be designed as pivots having a correspondingly adapted cross section, or as simple round pins or the like.

The driven toothing pitch circle described above is especially easy to achieve if the toothed links are of asymmetrical design with regard to the drive toothing and the driven toothing. This makes it possible to optimize the drive toothing with regard to a drive sprocket, for example, and the driven toothing with regard to a driven sprocket, for example.

With the present disclosure it is possible, in particular, to obtain an improvement of the contact ratio in the case of a tangential engagement. In addition it is possible to achieve an especially advantageous engagement of a sprocket in the external contour of the present toothed chain with bent links in an arc of contact of an internally driven sprocket, especially for the coupling of multiple chain drives.

### BRIEF DESCRIPTION OF THE DRAWINGS

Further advantages, aims and characteristics of the present disclosure are explained with reference to the attached drawing and the following description, in which various duplex toothed chains, having a driven toothing pitch circle which is arranged inside the toothing of a toothed chain engagement device, are represented and described, for erxample. Components which in the individual figures correspond at least substantially with regard to their function may here be identified by the same reference numerals, although these components need not be numbered or explained in all figures. In the drawing:

FIG. 1 schematically shows a view of an arrangement comprising a duplex toothed chain, an inner drive or return sprocket and an outer driven sprocket;

FIG. 2 schematically shows a view of a toothed chain drive with the arrangement in FIG. 1;

FIG. 3 schematically shows a side view of a further toothed chain with guide links arranged on the drive side;

FIG. 4 schematically shows a top view of the further toothed chain in FIG. 3;

FIG. 5 schematically shows a view of a further arrangement comprising a duplex toothed chain and a driven sprocket engaging tangentially therein;

FIG. 6 schematically shows a further view of the arrangement in FIG. 5 in a further-rotated position of the driven sprocket; and

FIG. 7 schematically shows a view of another arrangement comprising the duplex toothed chain in FIGS. 5 and 6 and a driven rack engaging tangentially therein; and

FIG. 8 schematically shows a view of a conventional duplex toothed chain of prior art in engagement with a driven sprocket.

### DETAILED DESCRIPTION

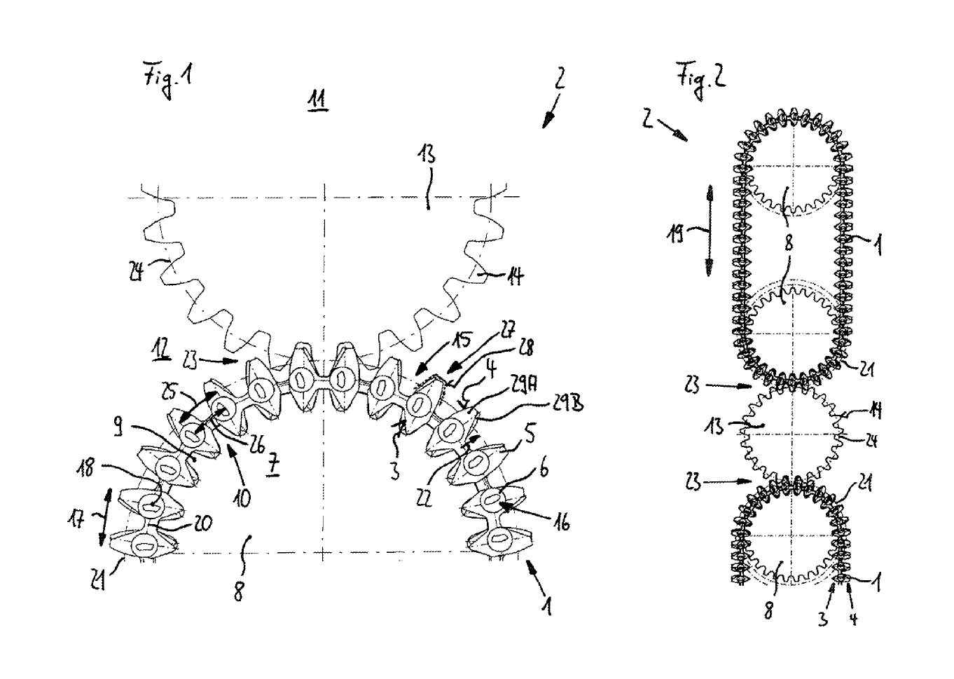

According to the arrangement 2 illustrated, the duplex toothed chain 1 shown in FIGS. 1 and 2 comprises a drive toothing 3, a driven toothing 4, asymmetrical toothed links 5 and joint links 6.

According to the arrangement 2 the toothed chain 1 meshes on the drive toothing side 7 with an internally arranged drive or return sprocket 8. Here the toothed chain 1 wraps around the drive or return sprocket 8 with a wrap contact radius of approximately 180°, drive teeth 9 (here numbered only by way of example) of the drive or return sprocket 8 engaging on the drive toothing side 7 in corresponding toothed link spaces 10 of the asymmetrical toothed links 5.

At the end face 11 of the drive or return sprocket 8, on the driven toothing side 12, is a driven sprocket 13 as special sprocket, which with its external toothing 14 engages in corresponding toothed link spaces 15 of the driven toothing 4 of the toothed chain 1.

With regard to the tooth shape and the engagement angle, the geometry of the external toothing 14 is specially adapted to the toothed chain 1, in order to achieve the optimum possible engagement and stability ratios. The bending in the area of the joint links 6 modifies the engagement geometry, formed by the angular position of the interconnected, asymmetrical toothed links 5.

An essential aim of the disclosure here is to achieve the greatest possible engagement length or overlap contact between driven toothing-side 12 toothed chain teeth (not separately numbered here) of the asymmetrical toothed links 5 and the external toothing 14 of the driven sprocket 13.

The individual asymmetrical toothed links 5 are pivotally interconnected by means of joint links 6, the joint links 6 being embodied as rocker links 16. For receiving the joint links 6, the asymmetrical toothed links 15 comprise joint apertures 18, which are spaced at intervals from one another in the longitudinal direction 17 and in which the joint links 8 are supported.

A joint aperture pitch circle 20, which in conventional toothed chains defines the actual pitch circle, extends in the longitudinal extent 19 (see FIG. 2) of the duplex toothed chain 1 at the level of the joint apertures 18. The present toothed chain 1, however, advantageously has a driven toothing pitch circle 21, which is different from this and from a drive toothing pitch circle. To this extent, distinctive features of the duplex toothed chain 1 are the driven toothing pitch circle 21 and a drive toothing pitch circle (not drawn in here), which are each arranged at different radial distances from the joint aperture pitch circle 20.

The driven toothing pitch circle 21 here lies radially 22 further outwards than the joint aperture pitch circle 20, so that, at least in the meshing area 23 of the arrangement 2, the driven toothing pitch circle 21 lies inside the external toothing 14 of the driven sprocket 13, in a manner similar to a pair of mating spur gears.

In the meshing area 23 the driven toothing pitch circle 21 advantageously coincides at least partially with an external toothing pitch circle 24 of the external toothing 14, or touches this.

With regard to a toothed chain 1 bent in the direction of the drive teeth 9, the driven toothing pitch circle 21 has a greater pitch 25 than the pitch 26 of the joint aperture pitch circle 20, so that substantially better engagement conditions can be obtained in the meshing area 23.

This is simple to achieve in design terms, since the toothed links 5 are of asymmetrical design with regard to the drive toothing 3 and the driven toothing 4.

Here, at least on the driven side, two toothed links 5 arranged next to one another in the direction of a single joint link 6—perpendicular to the plane of the paper—together form a driven toothing tooth contour 27, having a generating curve 28 of the driven toothing tooth contour 27 which is formed by two individual teeth 29A and 29B that are non-congruent in the fitted position (with regard to the toothed links 5 arranged next to one another). Here the individual teeth 29A, 29B may be formed laterally inverted relative to one another, for example. This generating curve 28 is variable, according to how heavily the individual toothed links 5, arranged in axial series, of the duplex toothed chain 1 are set in relation to one other, particularly in the wrap contact area of the drive or return sprocket 8.

The arrangement 2 illustrated shows a first exemplary embodiment of a duplex toothed chain drive 30, in which the drive and return sprockets provided with reference numeral 8 are normally toothed sprockets, the toothing systems of which are designed for a wrap-around drive. The two toothed chain section drives 31 and 32 of the toothed chain drive 30 are positively interconnected for the transmission of power and motion by the engagement of the driven sprocket 13.

The further duplex toothed chain 101 shown in FIGS. 3 and 4 and provided with a drive toothing 3 and a driven toothing 4 is represented in an extended state. Here the duplex toothed chain 101 has a driven toothing pitch circle, which is arranged radially further distant from a joint aperture pitch circle than a drive toothing pitch circle is arranged radially distant from the joint aperture pitch circle. Besides asymmetrical toothed links 5 and corresponding joint links 6, the further toothed chain 101 additionally also comprises unilaterally acting guide links 33, which guide the duplex toothed chain 101 substantially only on the side of the drive toothing 3 opposite a drive or return sprocket 8. The function of the guide links 33 is essentially to stabilize a straight-line running of the toothed chain 101 on an external toothing 14 of the driven sprocket 13 in a transverse direction 34.

With regard to the toothed chain 101 shown in FIGS. 3 and 4, the guidance is needed only on the drive or return sprocket 8; to this extent the guide link 33, for the purposes of the disclosure, is also only of unilateral design. This is advantageous in ensuring that a toothed chain engagement device acting on the driven toothing 4 is not necessarily tied in its width to the width of the duplex toothed chain 101, but may if necessary be of broader design than the toothed chain 101.

In the further arrangement 102 shown in FIGS. 5 and 6 a driven sprocket 13 engages with an external toothing 14 tangentially in a driven toothing 4 of an alternative duplex toothed chain 201. In this exemplary embodiment also, the duplex toothed chain 201 has a drive toothing 3 of a design different from the driven toothing 4, the two different toothings 3 and 4 again being particularly easy to achieve in design terms through asymmetrically formed toothed links 5. The asymmetrical toothed links 5 are connected together by means of joint links 6. In addition, the asymmetrical toothed links 5, on the driven toothing side 12, are adapted in their link contour, in an area 35 destined for the tangential engagement, to another tooth contour 36 and to another angle of engagement of the tangential driven sprocket 13, in such a way that, here too, the greatest possible overlap contact is achieved for an especially harmonious and uniform running free of backlash. In order to be able to correspond optimally both to a drive sprocket (not shown) and to the driven sprocket 13, the duplex toothed chain 201 also has a driven toothing pitch circle 21 of the driven toothing 4 which is different from the joint aperture pitch circle 20 and which is arranged radially further distant from the joint aperture pitch circle 20 than a drive toothing pitch circle of the drive toothing 3 is arranged radially distant from the joint aperture pitch circle 20 (see FIG. 1, in particular).

In the other arrangement 202 shown in FIG. 7 an external contour 37 of a rack segment 38 of a driven output (not shown further here) engages on the driven toothing side 12 in a duplex toothed chain 1 having a drive toothing 3 and a driven toothing 4. Again, other distinctive features of the duplex toothed chain 1 shown in this exemplary embodiment are asymmetrical toothed links 5 and joint links 6, which connect these toothed links 5 together. The alternative toothed chain 201 shown according to the other arrangement 202 here corresponds to the duplex toothed chain 1 in FIGS. 1 and 2.

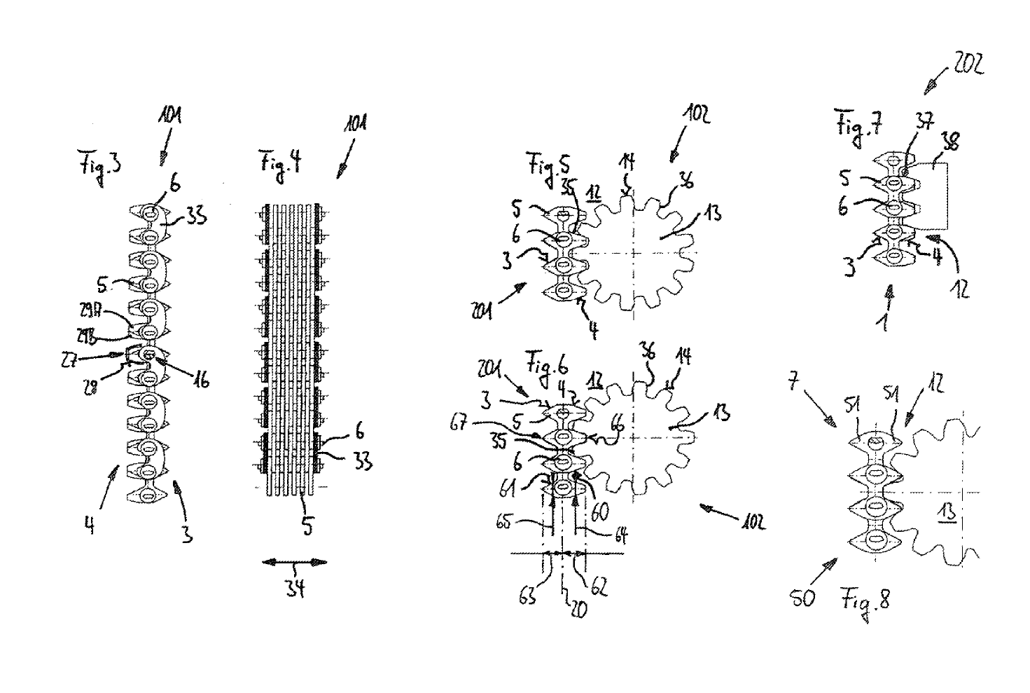

The duplex toothed chain 50 disclosed by the prior art, shown just for comparison in FIG. 8, comprises symmetrically formed drive toothing 3 and driven toothing 4 having teeth 51 identically formed on both sides. To this extent both a driven sprocket 13 and a drive sprocket (not shown here) each have to mesh with identically formed teeth 51.

It will be readily apparent from the duplex toothed chains 1, 101 and 201 according to the disclosure, especially by comparison with the known chain, that driven teeth 60 (numbered by way of example in FIG. 6) there oriented on the driven toothing side 12 are arranged asymmetrically in relation to drive teeth 61 oriented on the drive toothing side 7. In particular, the driven teeth 60 oriented on the driven toothing side 12 have a larger height 62 than the height 63 of the drive teeth 61, compared to the drive teeth 61 oriented on the drive toothing side 7.

In addition, due to their different design shape, the driven teeth 60 and the drive teeth 61 each have different half-width values 64 and 65. This is larger in the case of the driven teeth 60 than in the drive teeth 61.

Furthermore a distinctive feature of the driven teeth 60 is cropped tooth ends 66, whereas tooth ends 67 of the drive teeth 61 taper more sharply to a point (cf. FIG. 6).

With regard to the exemplary embodiments according to FIGS. 1 to 4 and 7, the driven teeth 60 consist of the individual teeth 29A and 29B already described previously.

It will be obvious that the exemplary embodiments explained above are only initial developments of the duplex toothed chain according to the disclosure. The development of the disclosure is in this respect not limited to these exemplary embodiments.

The applicant reserves the right to claim all features disclosed in the application documents as essential for the disclosure, provided that they, whether individually or in combination, are novel compared to the prior art.

What is claimed is:

1. A duplex toothed chain, comprising:
a drive toothing defining a drive toothing pitch circle;
a driven toothing defining a driven toothing pitch circle;
toothed links; and
joint links,
wherein the toothed links define joint apertures that are spaced at intervals from one another in a longitudinal direction and that are configured to receive the joint links, the joint apertures defining a joint aperture pitch circle extending in a longitudinal extent of the duplex toothed chain, and
wherein the driven toothing pitch circle is different from the joint aperture pitch circle and is arranged radially further distant from the joint aperture pitch circle than the drive toothing pitch circle is arranged radially distant from the joint aperture pitch circle.

2. The duplex toothed chain according to claim 1, wherein the driven toothing has a driven toothing pitch and the drive toothing has a drive toothing pitch, the driven toothing pitch being greater than the drive toothing pitch.

3. The duplex toothed chain according to claim 1, wherein the driven toothing has a module toothing having a pressure angle of between 15° and 30°.

4. The duplex toothed chain according to claim 1, wherein the duplex toothed chain, at least on a driven toothing side, has a driven toothing tooth contour with a variable generating curve from at least two individual teeth arranged so that they are rotationally moveable in relation to one another.

5. The duplex toothed chain according to claims 1, wherein the duplex toothed chain has toothing pitch circles arranged asymmetrically in relation to the joint aperture pitch circle.

6. The duplex toothed chain according to claim 1, wherein the toothed links are arranged asymmetrically with regard to the drive toothing and the driven toothing.

7. The duplex toothed chain according to claim 1, wherein the driven toothing pitch circle with regard to a toothed chain bent in the direction of the drive toothing has a larger driven toothing pitch than the pitch of the joint aperture pitch circle.

8. The duplex toothed chain according to claim 1, further comprising guide links configured to exert a guiding action on one side only.

9. The duplex toothed chain according to claim 1, wherein the joint links each comprise a rocker link.

10. The duplex toothed chain according to claim 1, wherein driven teeth of the toothed links oriented on the driven toothing side have a larger height in relation to the joint aperture pitch circle than drive teeth of the toothed links oriented on the drive toothing side in relation to the joint aperture pitch circle.

11. The duplex toothed chain according to claim 1, wherein driven teeth of the toothed links oriented on the driven toothing side have a half-width value which is greater than a half-width value of the drive teeth of the toothed links oriented on the drive toothing side.

12. The duplex toothed chain according to claim 1, wherein driven teeth of the toothed links oriented on the driven toothing side have cropped tooth ends and drive teeth of the toothed links oriented on the drive toothing side have tooth ends tapering more sharply to a point.

13. An arrangement, comprising:
at least one duplex toothed chain having a drive toothing and a driven toothing; and
at least one external toothing of a toothed chain engagement device,
wherein the driven toothing and the external toothing intermesh in a meshing area,
wherein the driven toothing defines a driven toothing pitch circle, and
wherein the driven toothing pitch circle is arranged inside the external toothing of the toothed chain engagement device.

14. The arrangement according to claim 13, wherein the driven toothing pitch circle in the meshing area at least partially coincides with an external toothing pitch circle of the external toothing or touches the external toothing pitch circle.

15. The arrangement according to claim 13, wherein the toothed chain engagement device comprises a sprocket or a rack.

16. The arrangement according to claim 13, wherein the duplex toothed chain further includes:
toothed links; and
joint links,
wherein the drive toothing defines a drive toothing pitch circle,
wherein the toothed links define joint apertures that are spaced at intervals from one another in a longitudinal direction and that are configured to receive the joint links, the joint apertures defining a joint aperture pitch circle extending in a longitudinal extent of the duplex toothed chain, and
wherein the driven toothing pitch circle is different from the joint aperture pitch circle and is arranged radially further distant from the joint aperture pitch circle than the drive toothing pitch circle is arranged radially distant from the joint aperture pitch circle.

17. The duplex toothed chain according to claim 3, wherein the pressure angle of the module toothing of the driven toothing is between 19° and 25°.

18. The duplex toothed chain according to claim 8, wherein the guiding action of the guide links is exerted on the drive toothing.
